(19) United States
(12) Patent Application Publication
(10) Pub. No.: US 2006/0157655 A1
(43) Pub. Date: Jul. 20, 2006

(54) System and method for detecting hazardous materials

(76) Inventors: Richard Mammone, Warren, NJ (US); Christine Podilchuk, Warren, NJ (US); Joseph Wilder, Princeton, NJ (US)

Correspondence Address: MATHEWS, SHEPHERD, MCKAY, & BRUNEAU, P.A., 100 THANET CIRCLE, SUITE 306, PRINCETON, NJ, 08540, US

(21) Appl. No.: 11/038,300

(22) Filed: Jan. 19, 2005

(51) Int. Cl. G01T 1/00

(52) U.S. Cl. 250/395

(57) ABSTRACT

The present invention relates to mitigating the effects of distortions in pulse shape and energy of spectrum from gamma ray and/or neutron detectors. In one embodiment, the present invention uses pattern recognition techniques to identify and separate various distortions in the pulse shape and energy to obtain a better estimate of the true number of pulses of specific energies which are characteristic of the radioactive materials present. Additionally, autoregressive models, pulse filtering and pattern recognition methods are used to obtain more accurate pulse characterization. In one embodiment, the present invention relates to a method of detecting a material comprising the steps of deriving an energy spectrum from nuclear radiation detected from the material, processing the energy spectrum for enhancing the energy spectrum, extracting one or more features from the enhanced energy spectrum, and classifying the material based on the one or more features.

### BACKGROUND OF THE INVENTION

1. Field of the Invention

This invention relates generally to gamma ray and neutron detectors, and in particular, to signal processing and pattern recognition methods to enhance performance of gamma ray and neutron detectors.

2. Description of Related Art

Methods have been described to provide information representing the likelihood that an object contains a crystal structure associated with any of several known contraband substance, as, for example, any of several known illegal drugs or any of several known explosives. U.S. Pat. No. 6,118,850 discloses analysis methods for x-ray differentiation patterns to classify a crystal structure of an object. The method includes the steps of applying a beam of incident x-ray radiation through the object, detecting diffracted x-ray radiation from the object and deriving a spectrum of the diffracted x-rays. The method can further include the step of extracting a plurality of features from the diffracted x-ray spectrum constituting a feature set and classifying the structure of the object by a probabilistic technique in which a plurality of the features in the feature set contribute to the probability that the structure belongs to a particular one of a plurality of classes. For example, the classifying step can include the step of subjecting the features in the feature set to processing in a classifier such as a multilayer perceptron network or a neural tree network which has been trained using one or more spectra representing x-rays diffracted by one or more known substances. The features included in the feature set may include individual elements of the spectrum such as energy and intensity values of peaks or troughs, and energy and intensity values of centroids of regions of the spectrum lying within preselected energy ranges. The step of extracting the set of features from the spectrum can include the step of applying a transform to the spectrum so as to provide a set of coefficients such that each coefficient depends on the entirety of the spectrum. Alternatively, a method for examining a crystal structure of an object of the present invention can be performed separately with respect to each of a plurality of volume elements in the object being examined so as to provide separate structural classification information with respect to each such volume element as, for example, a separate indication of the presence or absence of contraband in that volume element.

Gamma ray detectors are known for monitoring radioactive materials. U.S. Pat. No. 5,539,788 describes a system having an array of gamma ray detectors for detecting gamma radiation from soil. Gamma ray detectors use the process of neutron activation at a nuclear level. A neutron of energy E collides with the nucleus of an atom in the sample and initiates a reaction. For a neutron of thermal energy, the reaction might be absorption of the neutron into the nucleus, creating the next higher mass isotope of that element. If the neutron is more energetic (e.g., with several mega-electronvolts of kinetic energy), other nuclear reactions are possible. These other reactions include inelastic scattering from the nucleus, exciting the atom according to its internal structure of quantum levels, or other reactions ((n,p), (n, alpha), (n,2n), etc.) in which nuclear transmutation to another element occurs. In each of these cases, the residual nucleus is left in a highly excited internal state, and decays to its ground state almost instantaneously (10⁻¹⁴ seconds or less), emitting a gamma ray of several mega-electronvolts of energy. The energy of this gamma ray is uniquely characteristic of the quantum structure of the residual nucleus, and thus is a signature of the original target nucleus. The number of atoms of each of the elements of interest in a sample can be estimated by detecting and collecting the spectrum of gamma rays emitted by the sample and integrating the appropriate peaks.

Conventional scintillation detectors produce pulses of different heights proportional to their energies, which are counted to produce an energy spectrum characteristic of the gamma rays produced by various radioactive isotopes. However, a number of phenomena interact to produce distortions in pulse shape and energy. Among the more severe distortions are pulse pile-up (overlapping pulses), ballistic deficit (inaccurate sampling) and fast decay pulses due to neutron activity.

It is desirable to provide a system and method to improve detection and classification of spectra from gamma ray detectors and/or neutron detectors.

### SUMMARY OF THE INVENTION

The present invention relates to mitigating the effects of distortions in pulse shape and energy of spectrum from gamma ray and/or neutron detectors. For example, the present invention provides a means of improving detection when there is spectral peaks of benign materials which can interfere with the detection of peaks of hazardous materials. In one embodiment, the present invention uses pattern recognition techniques to identify and separate various distortions in the pulse shape and energy to obtain a better estimate of the true number of pulses of specific energies which are characteristic of the radioactive materials present. Additionally, autoregressive models, pulse filtering and pattern recognition methods are used to obtain more accurate pulse characterization.

In one embodiment, the present invention relates to a method of detecting a material comprising the steps of deriving an energy spectrum from nuclear radiation detected from the material, processing the energy spectrum for enhancing the energy spectrum, extracting one or more features from the enhanced energy spectrum, and classifying the material based on the one or more features.

In one aspect of the invention, novel digital signal processing and pattern recognition techniques are used to improve the performance of inexpensive, un-cooled gamma ray and neutron detectors to match the performance of more expensive cooled systems.

The invention will be more fully described by reference to the following drawings.

### BRIEF DESCRIPTION OF THE DRAWINGS

FIG. 1 is a flow diagram of a method for detecting one or more materials.

FIG. 2 is a schematic diagram of a system for detecting one or more materials.

FIG. 3 is a flow diagram of a method for spectrum enhancement during preprocessing.

FIG. 4 illustrates an example background spectrum.

FIG. 5A is a graph of a curve of a low energy cumulative spectrum.

FIG. 5B is a graph of a curve of a high energy cumulative spectrum.

FIG. 5C is a graph of a low energy curve fit of FIG. 5A.

FIG. 5D is a graph of a high energy curve of FIG. 5B.

FIG. 6A illustrates a spectrum of raw data from detection of Cs-137 before application of a background subtraction method.

FIG. 6B illustrates a resulting spectrum after application of the background subtraction method.

FIG. 6C illustrates a spectrum of raw data from detection of Cs-137 before application of the background subtraction method.

FIG. 6D illustrates a resulting spectrum after application of the background subtraction method.

FIG. 7A is an illustration of an original spectrum.

FIG. 7B is an illustration of the result of a Min operation on the original spectrum shown in FIG. 7A.

FIG. 7C is the result of a Max operation of the spectrum determined in FIG. 7B.

FIG. 7D is an illustration of the result of subtraction of the spectrum determined in FIG. 7C from the original spectrum shown in FIG. 7A.

FIG. 8 is a flow diagram of an embodiment of a preprocessing method.

FIG. 9A illustrates a resulting spectrum after application of the preprocessing method of FIG. 8 to the spectrum shown in FIG. 5A.

FIG. 9B illustrates a resulting spectrum after application of the preprocessing method of FIG. 8 to the spectrum shown in FIG. 5B.

FIG. 10A illustrates a two dimensional plot of cepstral features when Cs-137 is present and cepstral features when Cs-137 is not present.

FIG. 10B illustrates a three-dimensional plot of cepstral features when Cs-137 is present and cepstral features when Cs-137 is not present.

FIG. 11 is a schematic diagram of an implementation of a plurality of classifiers.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

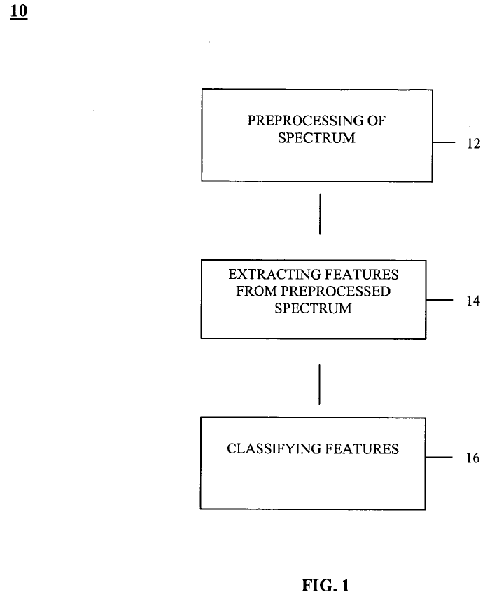

A method for detecting one or more materials 10 in accordance with the teachings of the present invention is shown in FIG. 1. In block 12, a spectrum captured by a detector is processed to correct for system dependent artifacts and provide a modified spectrum. In block 14, one or more features are extracted from the modified spectrum. The features identified will allow an identification of a material to be detected or the presence or absence of a type of material, such as a hazardous material. In block 16, the extracted features are classified by one of a variety of methods to identify the material being detected.

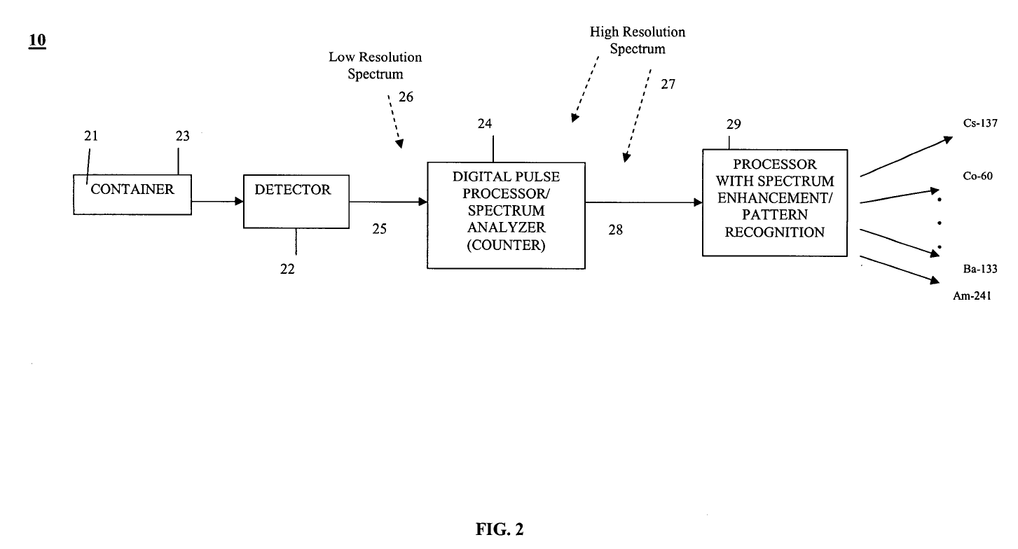

FIG. 2 is a schematic diagram of a system for detecting one or more materials 20 in accordance with the teachings of the present invention. Material 21 can be contained in a container 23. For example, container 23 can include a containing device for holding material 21, such as, for example, luggage or a vehicle. Detector 22 monitors one or more materials 21 within a vicinity of the detector.

In one embodiment, detector 22 can be hand held and moved within a vicinity of the material to be detected. For example, detector 22 can be a gamma ray and/or neutron detector. Detector 22 typically comprises a source of neutrons, or a source of gamma radiation, one or more neutron detectors, or one or more gamma ray detectors or some combination of these different types of sources and detectors. Detector 22 can include fast neutron interrogation and/or slow neutron interrogation. Suitable detectors 22 can include crystals of, for example, NaI, SAI, CdZnTz, and the like. An example detector 22 is manufactured by Amptek as the Gamma 8000.

In one embodiment, detector 22 can operate at room temperature without being cooled. Detector 22 can be used to detect hazardous or nonhazardous materials. Components of detector 22 are selected according to the elements to be detected and the reactions to be used in detecting them. For example, activation through neutron capture is useful for detecting uranium, plutonium, californium, copper and other elements. Activation through gamma radiation is useful for detecting radioisotopes such as Cs-137, Co-57, Co-60, Thorium 232, Am-241 and Barium-133. In particular, dangerous radioisotopes which can be used as components in munitions, such as radionuclides Cs-137 and Co-60, can be detected with detector 22.

Pulse processor/spectrum analyzer 24, analyzes data 25 received from detector 22 and performs preprocessing of data 25 as described in block 12. Data 25 can include, for example, low-resolution spectrum 26 or high resolution spectrum 27 of pulses produced by detector 22. Pulse processor/spectrum analyzer 24 uses one or more signal processing techniques to effect pulse shaping of data 25 for enhancing resolution, improving signal-to-noise ratio, minimizing effects of Compton scattering and realizing neutron/gamma discrimination to generate modified spectrum 28, as described below.

Processor 29 performs additional processing of processed spectrum 28 as described in blocks 14 and 16. For example, processor 29 can use linear or nonlinear filtering techniques for providing spectrum enhancement. Features can be extracted from the spectrum in the presence of multiplicative disturbances. Processor 29 can also provide classification of materials. For example, dangerous radionuclides can be distinguished from benign materials. In one embodiment, a neural tree network (NTN) or pattern recognition is provided to classify materials, as described below.

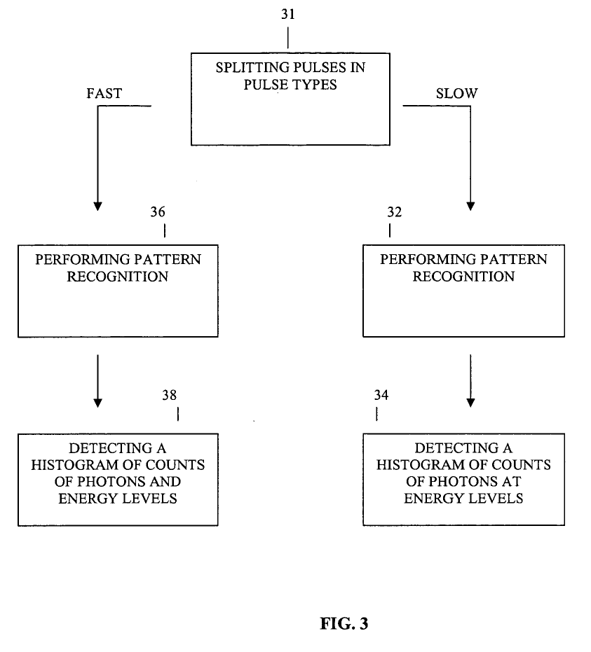

FIG. 3 is a flow diagram of a method which can be used during preprocessing in block 12 to provide spectrum enhancement based on the pulse shape. In block 31, pulses in data 25 are split into different pulse types. The pulse types can be determined from the pulse shape. The shape of the pulses can be used to detect particle interactions, such as neutrons, by determining delay times. For example, block 31 can split pulses into a first type of pulse of a wide pulse, such as pulses corresponding to fast neutrons having a width in the range of about 250 ns; and into a second type of pulse of a narrow pulse, such as pulses corresponding to Gamma radiation having a width in the range of about 100 ns.

In block 32, pattern recognition is performed on the first type of pulse, such as a wide or slow pulse. Pattern recognition can be performed using a suitable classifier for this type of pulse which typically has wide pulse. For example, the classifier can be suitable fast neutron recognition. In block 34, a graphical representation, such as a histogram, is determined for each classified pulse at particular energy levels. For example, the histogram can include counts of pulses at particular energy levels, such as 1 Ev, 2 Ev, and the like. In block 36, pattern recognition is performed on a second type of pulse, such as a narrow or fast pulse. Pattern recognition can be performed using a suitable classifier for this type of pulse. For example, the classifier can be suitable for Gamma and x-ray recognition which typically has a narrower pulse. In block 38, a graphical representation, such as a histogram, is determined for each classified pulse at particular energy levels.

The spectrum captured by detector 22 can include artifacts arising from the detector's photomultiplier tube and other sources. Drift in the energy spectrum can occur resulting in a shift in the location of photopeaks and other features. In one embodiment, preprocessing can be used for mitigating drift and other background noise. A background spectrum can be used for tracking drift of the energy spectrum. The background spectrum can be collected over intervals when it is known that there is only background radiation present. The determined background spectrum can be stored for later processing.

Spectral data taken at various intervals can be accumulated and combined to achieve a high signal-to-noise ratio of the background spectrum. This procedure can be used with differences in the background conditions. For example, the background spectrum can include containers such as luggage or vehicles for carrying hazardous materials. Spectra can be extracted under various conditions such as when no containers are present, when containers are present without hazardous materials present and when containers and hazardous materials are present.

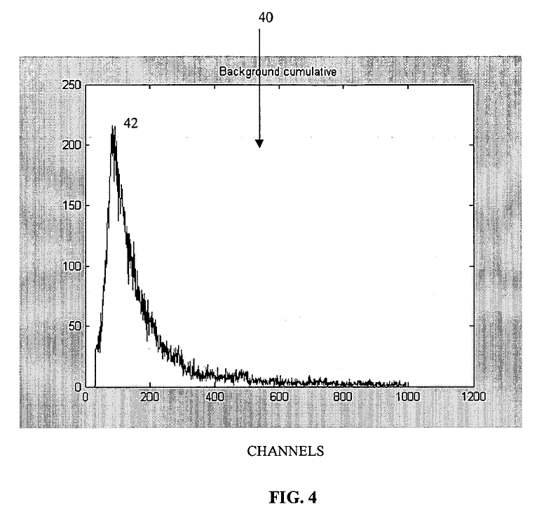

FIG. 4 illustrates an example background spectrum 40. A feature of background spectrum is found at 42 of the raw spectrum where a sharp peak due to the response of the detector can be found in the neighborhood of channel 100 (approximately 140 KEV) in this particular calibration. The background spectrum can be used as the basis for the background subtraction as described below.

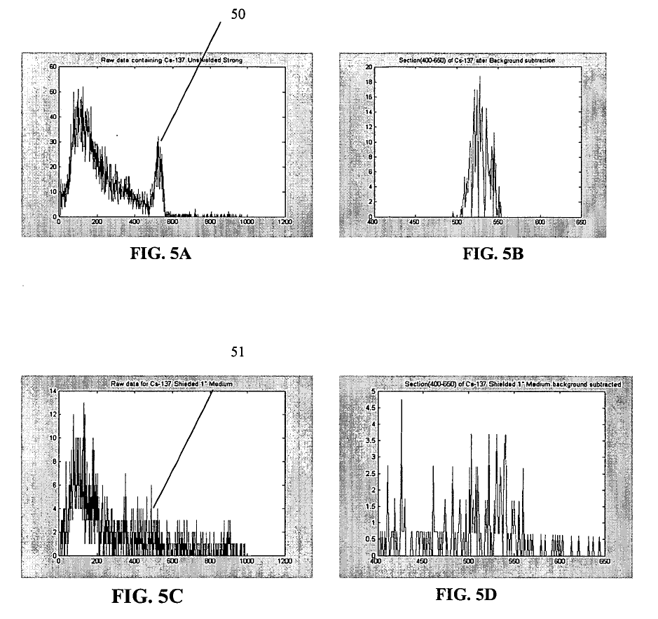

In an alternative embodiment, curves can be fit to the rising and/or falling portions of the background spectrum and their intersection can be computed. FIG. 5A is a graph of a curve of a low energy cumulative spectrum. The spectrum includes prominent photopeak 50. FIG. 5B is a graph of a curve of a high energy cumulative spectrum. FIG. 5C is a graph of a low energy curve fit of FIG. 5A. The spectrum includes buried photopeak 51. FIG. 5D is a graph of a high energy curve of FIG. 5B. The curve fit to the background spectrum can be used in background subtraction as described below.

In one embodiment, a background subtraction method is used to produce a modified spectrum for further processing. In this method, a test spectrum is determined for the material to be detected. Using a portion, or portions, of a test spectrum for the material to be detected where there is a high confidence that there are no features from the hazardous material, such as radionuclide, under test, a scale factor is extracted to match the stored background spectrum to the test spectrum. The scaled background spectrum can then be subtracted from the test spectrum to produce a modified spectrum for further processing. Scale factors for several portions of the spectrum where no hazardous material, such as radionuclides, are expected can be calculated and outliers due to unexpected benign hazardous material, such as radionuclides, can be discarded. This method increases the robustness of the scale factor computation.

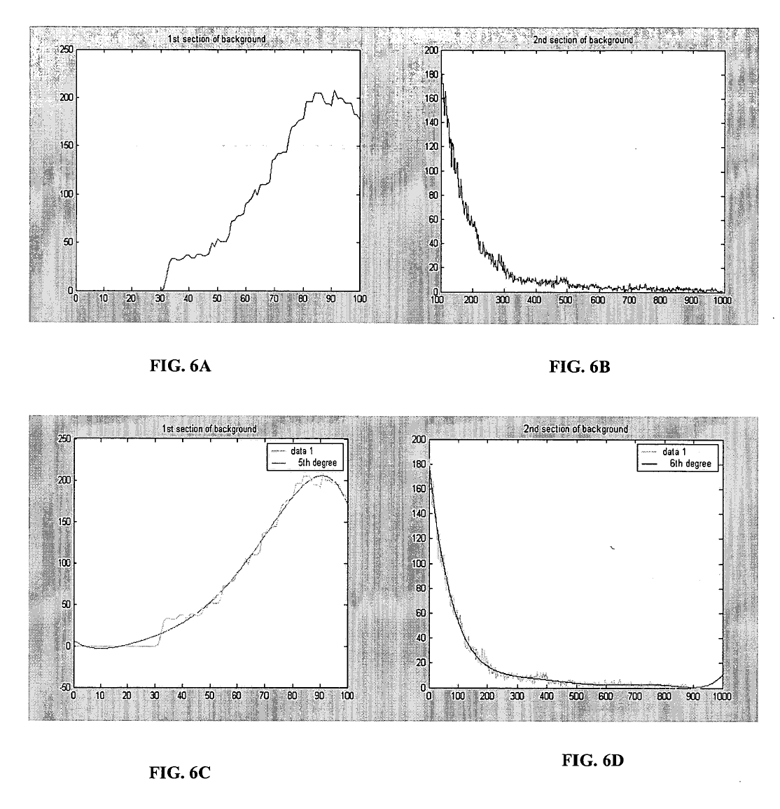

FIGS. 6A and 6B illustrate examples of results of using the background subtraction method described above. FIG. 6A illustrates a spectrum of raw data from detector 22 from detection of Cs-137 before application of the background subtraction method. FIG. 6B illustrates a resulting spectrum after application of the background subtraction method illustrating improvement in recognizing prominent photopeak 50. FIG. 6C illustrates a spectrum of raw data from detector 22 from detection of Cs-137 before application of the background subtraction method. FIG. 6D illustrates a resulting spectrum after application of the background subtraction method illustrating improvement in recognizing buried photopeak 51.

In an alternate embodiment, a Min/Max filtering can be used to remove background in the neighborhood of a photopeak. This technique is useful if there are unknown variations in the background, such as containers of a particular size and shape or when scaling is not possible due to the presence of a large number of interfering materials. In this embodiment, a Min/Max determination of the original spectrum is subtracted from the original spectrum. The Min operation uses a neighborhood that removes a photopeak from the spectrum. The Max operation uses the same neighborhood to restore the background to its original scale without the photopeak.

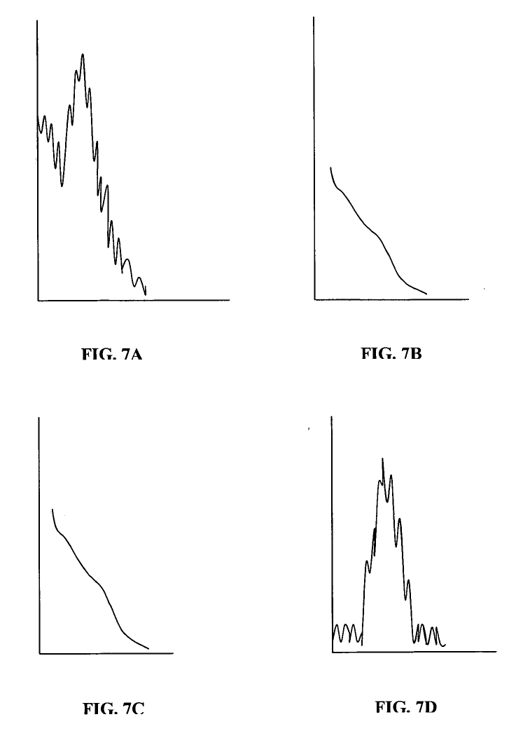

FIGS. 7A-7D illustrate the use of Min/Max filtering to perform background subtraction. FIG. 7A is an illustration of an original spectrum. FIG. 7B is an illustration of the result of a Min operation on the original spectrum shown in FIG. 7A. FIG. 7C is the result of a Max operation of the spectrum determined in FIG. 7B. FIG. 7D is an illustration of the result of subtraction of the spectrum determined in FIG. 7C from the original spectrum shown in FIG. 7A.

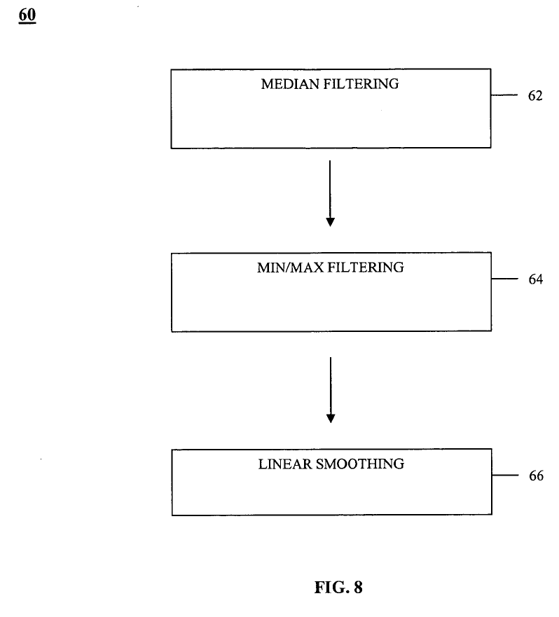

In one embodiment, preprocessing block 12 is implemented to perform enhancement and extraction of features from the original spectrum to generate modified spectrum 28 according to preprocessing method 60, shown in FIG. 8. Examples of features which can be extracted or enhanced include photopeaks and the Compton Edge. In block 62, median filtering is performed on the original spectrum. Median filtering can be used to remove sharp contrasts of features from spectrum.

In block 64, Min/Max filtering is performed on the spectrum generated by block 60. In one embodiment, Min/Max filtering provides replacing single points in the spectrum by a minimum value among its neighboring points and thereafter replacing the single point by a maximum value among its neighboring points. In one example, Min/Max filtering can remove narrow width noise peaks which are not captured by median filtering in block 62 and enhance photopeaks of materials to be detected. Min/Max filtering can take into account the full-width-half-maximum (FWHM) width of the photopeak located at a particular energy of the centroid. Photopeaks which are too narrow to actually be from a radioactive isotope are eliminated by using a small enough window which is passed over the spectrum. If too few samples are of significant value then high value samples are replaced with the lower neighboring values, thereby eliminating spurious peaks which might be confused with a material being present when it is not.

The spectrum determined after block 64 can be subdivided into several preselected energy ranges or bins. The energy ranges of the bins can have equal magnitude. The “center of gravity” or centroid of the portion of the spectrum lying in each energy range can be determined and used as features of the spectrum as described below.

In block 66, linear smoothing is performed on the spectrum generated by block 64. Suitable implementation for linear smoothing include any smoothing filter such as finite impulse response (FIR) or infinite impulse response (IIR) filters which can be designed using conventional filter design methods such as fornd Digital Signal processing software packages, such as by MATLAB. Alternatively, a Savitzky-Golay filter can be used for linear smoothing.

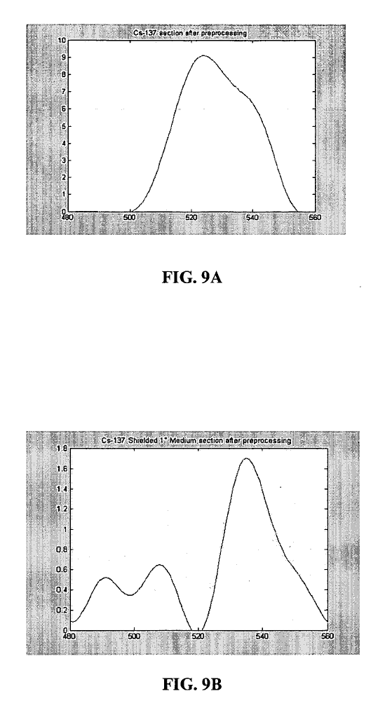

FIG. 9A illustrates a resulting spectrum after application of method 60 to the spectrum shown in FIG. 5B. FIG. 9B illustrates a resulting spectrum after application of method 60 to the spectrum shown in FIG. 5D.

In one embodiment, peak deconvolution to reshape the pulse train can be use during preprocessing in block 12. Peak deconvolution is used to process an energy region having two or more overlapping peaks. It has been found that projection onto corner sets (POCS) as described in J. von Neumann, Functional Operators, Vol. II (Ann. Math, Studies, No. 22), Princeton, N.J. 1950, p. 55, Theorem 13.7, hereby incorporated by reference into this application, can be used for nuclear spectra deconvolution.

For the nuclear spectra deconvolution problem, the problem can be expressed in discrete form as:

$$y ( i ) = {\sum }_{k = 0}^{N - 1} h ( i - k ) x ( k ) i = 0 , 1 , … N - 1$$

where y(i) is the measurement, x(i) is the ideal signal to be estimated and h(i) is the impulse response as measured from the instrument. The problem of estimating x can be formulated by taking the pseudoinverse as given by the measured data and applying constraints as given by the a priori information about the solution in an iterative algorithm based on POCS, as:
\tilde{x}^{(k+1)}=x*+QC\tilde{x}^{(k)}
where \tilde{x}^{(k)} is the estimate of x at the k^{th} iteration, x* represents the pseudoinverse solution, Q represents the null space of (H^{T}H) and C represents the projection operator on the a priori constraints of the solution. A priori constraints can include known energies of peak locations of interest in a spectrum from detector 22.

The spectrum from detector 22 or spectrum generated by pulse processor/spectrum analyzer 24 after preprocessing can be displayed in graphical form and can be recognized by a human technician as indicating the presence of detected materials. In an automatic method, the spectrum can be evaluated on the basis of a predefined set of features which can be automatically extracted by processor 29 processing the spectrum.

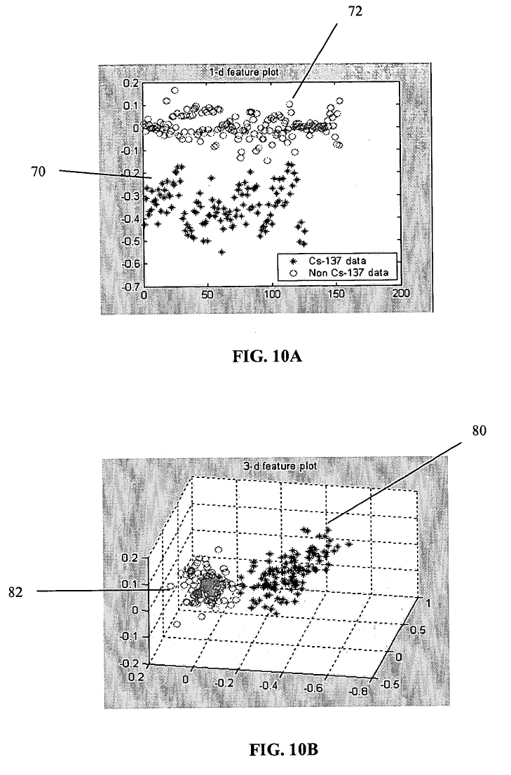

In one embodiment, the spectrum from detector 22 or after processing in pulse/processor spectrum analyzer 24 is analyzed to determine one or more features. For example, the features may include peak location, peak intensities, trough positions, trough intensities, FWHM width and geometric features of the spectrum, the center of gravity or centroid of the spectrum within each of several preselected ranges and energies and the parameters of curves to fit the peaks, troughs or centroids. A frequency spectrum analysis of the spectrum can be used to determine the features. One such method relies on a transformation of the spectrum into its cepstral representation. The cepstral representation includes an ordered set of cepstral coefficients defined by:

$$c ( n ) = \frac{1}{2 π} {\int }_{- π}^{π} log \vert X ( {ⅇ}^{jω} ) \vert {ⅇ}^{jwn} ⅆ ω$$

where c(n) is the nth coefficient, and X(e^{jw}) is the discrete Fourier transform of the diffraction spectrum x(n). In other words, the cepstrum is the inverse Fourier transform of the logarithm of the absolute value of the Fourier transform of the diffraction spectrum. In deriving the cepstral representation, the spectrum is treated as if it were a time domain signal. This process allows the underlying envelope of the spectrum to be separated from the original noise-corrupted spectrum. One or more cepstral features can be extracted and normalized to characterize features particular to specific materials even if the signals due to the materials are buried within complex noise disturbances. FIG. 10A illustrates a two dimensional plot of cepstral features 70 when Cs-137 is present and cepstral features 72 when Cs-137 is not present. FIG. 10B illustrates a three dimensional plat of cepstral features 80 when Cs-137 is present and cepstral features 82 when Cs-137 is not present.

Note that because the cepstrum is based on the logarithm of the absolute value of the discrete Fourier coefficients, variations in peak intensity due to absorption or material variation are compressed and de-emphasized. Other transforms, known as “homomorphic” transforms, which also incorporate a logarithmic transformation step, can provide similar insensitivity to absorption and material variation. Still other transforms of the type known as linear orthonormal transforms can be applied to feature extraction from the full diffraction spectrum. One such linear orthonormal transform is the discrete cosine transform (DCT). The DCT is generally similar to the cepstral transform. However, the DCT and other linear transforms do not include the logarithmic function found in the cepstral transform. Therefore, the DCT and other linear transforms do not tend to suppress the distortions such as variations in peak heights due to noise and the presence of nearby amorphous materials to the same degree as the cepstral transform.

Still other forms of analysis can be applied to feature extraction including modeling as a Gaussian model, using Principle Component Analysis, linear discriminate analysis and independent component analysis.

Once a feature set has been extracted from a diffraction spectrum, the feature set is used in block 16 to classify the material which is detected. For example, in examining luggage or a vehicle for the presence of explosives, a feature set may be derived from a spectrum of the explosives. The classification step accepts the feature set and arrives at an indication as to whether the material in the luggage or vehicle is or is not an explosive. Thus, the classification step determines whether the material belongs to a class associated with hazardous materials or to another class of structures associated with nonhazardous materials. Alternatively, the information in the feature set can be used to classify the type of the material as belonging to a particular class associated with a particular material.

The simplest form of automatic classification is a lookup and comparison scheme. Feature sets derived from known materials are stored, and the feature set derived from an unknown material is compared to each known feature set. For example, where the feature set consists of a table of peak energies and intensities, the table is compared to the corresponding tables for known materials. The material is classified as corresponding to the known material which has a table most closely matched to the table for the unknown material. Various rules for deciding which known table most closely matches the table for the unknown material may be employed. For example, in comparing a table of peak heights and intensities for an unknown material to a similar table for a known material, a mismatch in peak positions (energies) between known and unknown tables can be treated as more significant than a mismatch in heights (intensities) of the same peak in the known and unknown tables. The lookup and comparison scheme can also be applied to other feature sets discussed above.

Preferably, the classification step is performed by a probabilistic technique in which a plurality of features in the feature set contribute to the probability that the structure of the unknown material belongs to a particular class. Such a probabilistic technique relies on the feature set as a whole rather than on individual features. Although probabilistic classification techniques can include explicit, identifiable rules created by a programmer, the preferred techniques utilize a classification procedure which incorporates the results of training. For example, the classification algorithm can be used to process a training set consisting of feature sets for structures of known classification. The results of this processing are used to adjust the algorithm, so that the classification accuracy improves as the algorithm learns by processing the training sets.

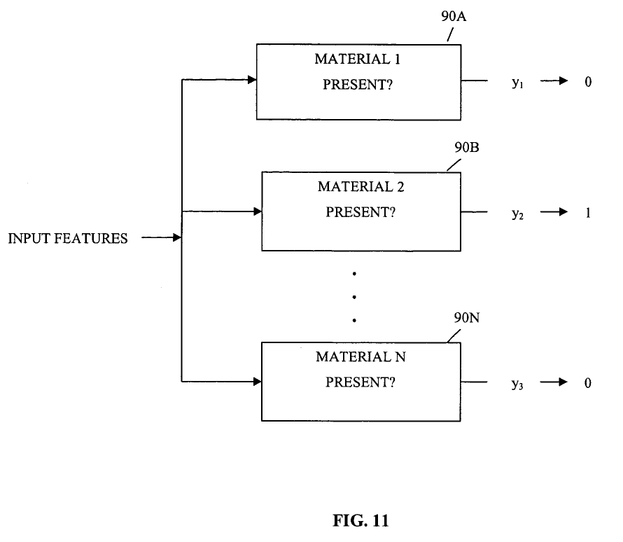

In one embodiment, a plurality of classifiers 90A-90N can be used in which each respective classifier is used for one type of material of interest, as shown in FIG. 11. Features determined from processor 29 are imported to classifiers 90A-90N. Each classifier 90A-90N provides output, y1−N of the presence of the type of material. Each classifier 90A-90N can include specific information for classification of a particular type of material, such as the location of the energy peak for the particular type of material or the FWHM peak width for the particular type of material.

One type of trainable classifier which can be used in block 16 is the artificial neural network. Various types of artificial neural networks can be employed. A particularly preferred form of artificial neural network known as a neural tree network is described in commonly assigned U.S. Pat. No. 5,634,087 and U.S. Pat. No. 6,118,850, the disclosure of each is incorporated by reference herein. The neural tree network as disclosed in the '087 Patent provides significant operational advantages such as ease of training and speed of operation. Other known types of neural networks, and other known forms of trainable classifiers also can be used. Indeed, using a given feature set, the same degree of classification accuracy can be achieved by many types of known trainable classifiers or neural networks. The training operation can be performed on one machine and the results can be replicated in additional machines. For example, training of a neural net results in a set of weight values defining the association between nodes of the net. This set can be recorded and incorporated in other, like nets.

The choice of features which are incorporated in the feature set will influence the accuracy achievable by a trainable classifier. Feature sets which incorporate features such as the peak positions, centroid positions and one or more curves such as a regression line fit to the centroids can provide useful accuracy. Whole-pattern feature sets, such as those incorporating cepstral or other transform coefficients as discussed above, in which each coefficient relates to the entire pattern of the spectrum, generally provide the best classification accuracy.

The output of the classification step for a particular volume element may be a “hard-limited” or binary indication as, for example, an indication that the particular volume element either does or does not have the structural features associated with a hazardous material. Alternatively, the output of the classification step may be a value such as a real number between zero and one indicating the degree of likelihood that the volume element has the structural features associated with a hazardous material.

Although the particulars of the classifier or neural network may be generally conventional, the following discussion of neural networks is provided for the sake of completeness. Artificial neural networks attempt to model human biological neural networks to perform pattern recognition and data classification tasks. Neural networks are fine grain parallel processing architectures composed of non-linear analog processing units which attempt to replicate the synaptic-dendritic interconnections found in the human brain. The processing units typically accept several inputs and create a weighted sum (a vector dot product). This sum in then tested against the activation rule (typically a simple threshold) and then processed through the output function. The output function is usually a non-linear function such as a hard-limiter or a sigmoid function. The connectivity pattern defines which processing units receive the output value of a previous node as their input. At each instant of propagation, the values for the inputs define an activity state. The initial activity state is defined upon presentation of the inputs to the network. The output at any given activity state is derived from the state values which represent the inputs to all processing units and the values of the weights. The weights are chosen so as to minimize the error between the produced result and the correct result. The learning rule defines how to choose the weight values. Several commonly used learning rules are back-propagation, competitive learning, adaptive resonance, and self-organization.

Once the neural network learns the weights (can correctly identify the feature data in the training set), it is allowed to classify unknown feature data. If the neural network were subjected to sufficient training data, and the learning rule were appropriate, then sufficient generalization should have occurred to allow the unknown feature data to be correctly classified.

The use of the highly parallel architecture intrinsic to neural networks has several advantages over traditional von Neumann architectures. These advantages include excellent performance which yields rapid classification, simple and inexpensive processing units, modular structure, robustness to element failure, and adaptive training strategies.

Pattern recognition systems attempt to correctly classify data sets which are representative of a specific class as members of that class. The pattern recognition systems is typically separated into two main subsystems, feature selection and feature classification.

Feature classification is a technique which tessellates the feature space into generalized regions which represent every separable class. The tessellation is performed by finding n dimensional hyperplanes which are used to divide the feature space and isolate each class region. The equations for the hyperplanes are determined by finding the best coefficients (commonly known as weights) which separate the feature vectors. Once the tessellation is determined, classification is performed by taking the dot product of the feature vector with each tessellating hyperplane. This allows the feature vector to be placed on one side or the other of each tessellating hyperplane thereby uniquely placing the feature vector in one class region.

Several types of neurons and neural networks have been proposed. Most have tried to imitate the structure and functionality believed to be present in the human brain. None have yet achieved the performance of the human brain, but satisfactory (even exceptional) results have been obtained using these architectures on pattern recognition tasks. The most popular type of neuron due to its versatility and performance is the perceptron. Network architectures of these perceptrons, specifically multilayer feedforward perceptron (MLP) networks, have been found to be very powerful and versatile due to the availability of efficient learning algorithms.

The MLP is the most widely studied and best understood architecture and therefore the most appropriate choice for determining preliminary classification performance. The major drawback to implementing MLP in hardware is the high cost of the parallel implementation, or conversely the slow processing speed of serial implementation.

The Neural Tree Network (NTN) has been studied as an alternative architecture. This tree structured neural network has significant implementation advantages and has been shown to provide performance equivalent to the MLP. It is therefore a viable alternative to the more computationally intensive approaches required by the MLP.

Although contemporary neural networks provide rigorous explanation for associative learning phenomenon, these systems have been restricted to learning specific tasks. Specifically, MLPs (Multi-Layer Perceptrons) have been widely employed for pattern classification tasks and provide a very simple feedforward structure for learning. The productivity of a neural network structure could be greatly enhanced if it use of past learning or experience could be used. In essence, if a model of a system could learn to learn then better generalization and quicker learning can be achieved.

The model EGO (Error Gain Orchestrator) can also be used. EGO uses a network of neural network modules which exhibit a faster learning mechanism and allow for the incorporation of these features into Neural Tree Networks. The neural network is able to generalize and retrain on any material whose spectra has been experienced in the past training process. Thus, the network has retention to enable it to generalize well over similar materials. EGO is an attempt to capture this behavior by using modules of MLP, where each neuron element is controlled by a super neuron or neural network which is also another MLP. This super net consists of neurons that remembers the trajectory its neuron followed for learning a particular task or a series of similar tasks.

Iterative gradient descent algorithms like the LMS algorithm have been used to perform classification tasks which are linearly separable. For nonlinear classification an extension of this algorithm known as the back-propagation algorithm is used. The Back-propagation algorithm is used over a network or neurons in layers called MLPs (Multi-Layer Perceptrons).

The iterative learning is performed over a set of vectors, Xᵢ, called the training set with which their desired outputs, yᵢ, have been specified. Typically these outputs are labels or classes into which the input vectors have to be classified. The iterative update generates a solution weight vector, Wₒₚₜ, which minimizes the error between the desired output and the actual output. Back-propagation is widely used for several applications and is a perfect example of learning by example. The model that we use extends this approach to perform learning by learning.

Gradient descent algorithms provide an efficient procedure by taking a set of randomly initialized weights network and updating them iteratively to an optimum set of weights which minimizes the error for the entire neural network. The optimum set of weights provides an optimal or a pseudo-optimal solution to the problem it is trained on.

The basis of formulating the EGO lies in the choice of parameters in the learning rule that allows faster learning or faster convergence for a given problem and also limits these parameters to a finite range of values over a series of tasks. Faster learning can be achieved by adjusting the gain parameter in a way such that the weights approach the optimum the fastest by the following: train the network to find a set of optimal weights, take the current weight vector in the weight update equation and find a pattern vector whose resultant with the current weight vector yields a vector whose angle with the optimum weight vector is the minimum. The best pattern vector from the training set is attempted to be found which yields the next weight vector in the update equation which is the nearest to the optimum.

Since the back-propagation rule is used for MLPs, every hidden node will have its own optimum step size corresponding to the optimum weight vector summed at that node. This vector approach is considered only from the input layer to the hidden layer. However, this metric could also be used between the hidden and output layers, if the outputs of the hidden node as a feature vector are considered.

The previous paragraph explained the metric used to modify the update rule to achieve faster convergence. This training is performed when the optimum weight vector is known. In order to remember the trajectories of this fast convergence, a mechanism can be adopted where the neural network will achieve comparable performance when the optimum weights vector is not known. To achieve this, a super net is trained for every neuron in the hidden layer. This super net is trained to learn the step sizes generated from the modified update rule. The input pattern to the super net is the current weight vector Wᵢ in the update equation and the best pattern vector Xₚ chosen from the training set.

The Super Net is trained over several weight sets and their desired optimal step sizes found by the metric explained above. After the Super Net has been trained, this network can be embedded in a normal MLP to guide each of its hidden nodes to convergence. Typically, each hidden node will have its corresponding super net which has been trained to remember the trajectories of convergence the hidden node has experienced.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A method for detecting a material comprising the steps of:
a. deriving an energy spectrum from nuclear radiation detected from said material;
b. processing said energy spectrum for enhancing said energy spectrum;
c. extracting one or more features from said enhanced energy spectrum; and
d. classifying said material based on said one or more features.

2. The method of claim 1 wherein said nuclear radiation is gamma radiation.

3. The method of claim 1 wherein said nuclear radiation is neutrons.

4. The method of claim 1 wherein in step b., said energy spectrum is enhanced based on a pulse shape of one or more pulses of said energy spectrum.

5. The method of claim 4 wherein step b. further comprises:
splitting said one or more pulses into a first type of pulse and a second type of pulse, said first type of pulse being a wide width and said second type of pulse being a narrow width; and
classifying said material with a classifier which is suitable for either said first type of pulse or said second type of pulse.

6. The method of claim 5 wherein said processing technique comprises linear or nonlinear filtering.

7. The method of claim 1 wherein said processing step b. further comprises the steps of collecting a background spectrum; and
subtracting said background spectrum from said energy spectrum.

8. The method of claim 7 further comprising the step of:
storing the background spectrum for subsequent use.

9. The method of claim 7 wherein said background spectrum is determined by curve fitting rising and/or falling portions of said background spectrum.

10. The method of claim 7 further comprising the step of:
detecting a scale feature between said background spectrum and a test spectrum from said material.

11. The method of claim 7 further comprising the step of:
detecting a scale factor between said background spectrum and a test spectrum of said material.

12. The method of claim 11 wherein said background spectrum is determined by curve fitting rising and/or falling portions of said background spectrum.

13. The method of claim 1 wherein step b. further comprises the steps of:
e. performing a Min operation to remove at least one peak from said energy spectrum; and
f. performing a Max operation on the energy spectrum generated by said Min operation in step e.; and
g. subtracting the energy spectrum generated by said Max operation in step f. from the original energy spectrum determined in step b.

14. The method of claim 13 further comprising the step of:
performing linear smoothing on the energy spectrum generated in step g.

15. The method of claim 1 wherein step b. further comprises the steps of:
e. performing median filtering of said energy spectrum;
f. performing Min/Max filtering on the energy spectrum generated in step e.;
g. performing linear smoothing on the energy spectrum generates in step. f.

16. The method of claim 1 wherein step b. further comprises using projection onto corner sets for deconvolution of one or more peaks in said energy spectrum.

17. The method of claim 1 wherein step d. comprises subjecting said features to processing in a classifier.

18. The method of claim 17 wherein said classifier is a multilayer perceptron network.

19. The method of claim 17 wherein said classifier is a neural tree network.

20. The method of claim 1 wherein said step of extracting one or more features from said energy spectrum includes the step of applying a transform to said spectrum so as to provide a set of coefficients such that each said coefficient depends on the entirety of said spectrum, said set of features including at least some of said coefficients provided by said transform.

21. The method of claim 20 wherein said transform is a homomorphic transform.

22. The method of claim 20 wherein said transform is a cepstrum transform yielding an ordered set of cepstral coefficients and wherein the set of features includes a set of cepstral coefficients.

23. The method of claim 22 wherein said set of features consists entirely of said cepstral coefficients.

24. The method of claim 20 wherein said transform is a discrete cosine transform.

25. The method of claim 1 wherein said classifying step is performed so as to provide structure classification information representing the likelihood that said object contains any of several known hazardous materials.

26. The method of claim 25 wherein said hazardous material is selected from Cs-137, Co-57, Co-60, Thorium 232, Am-241, Barium-133, Cs-137 and Co-60.

27. The method of claim 1 wherein step a. further comprises employing sodium iodide crystals, SAI and cadmium zinc tanzanium as gamma ray detectors.

28. The method of claim 1 wherein step a. further comprises employing a hand held detector.

29. A system for detecting a material comprising:
means for deriving an energy spectrum from nuclear radiation detected from said material;
means for processing said energy spectrum for enhancing said energy spectrum;
means for extracting one or more features from said enhanced energy spectrum; and
means for classifying said material based on said one or more features.

30. The system of claim 29 wherein said nuclear radiation is gamma radiation.

31. The system of claim 29 wherein said nuclear radiation is neutrons.

32. The system of claim 29 wherein said energy spectrum is enhanced based on a pulse shape of one or more pulses of said energy spectrum.

33. The system of claim 32 wherein said means for processing further comprises:
means for splitting said one or more pulses into a first type of pulse and a second type of pulse, said first type of pulse being a wide width and said second type of pulse being a narrow width; and
means for classifying said material with a classifier which is suitable for either said first type of pulse or said second type of pulse.

34. The system of claim 33 wherein said means for processing technique comprises linear or nonlinear filtering.

35. The system of claim 29 wherein said means for processing further comprises means for collecting a background spectrum; and
means for subtracting said background spectrum from said energy spectrum.

36. The system of claim 35 further comprising:
means for storing the background spectrum for subsequent use.

37. The system of claim 36 wherein said background spectrum is determined by curve fitting rising and/or falling portions of said background spectrum.

38. The system of claim 36 further comprising:
means for detecting a scale feature between said background spectrum and a test spectrum from said material.

39. The system of claim 36 further comprising:
means for detecting a scale factor between said background spectrum and a test spectrum of said material.

40. The system of claim 39 wherein said background spectrum is determined by curve fitting rising and/or falling portions of said background spectrum.

41. The system of claim 29 wherein said means for processing further comprises:
means for performing a Min operation to remove at least one peak from said energy spectrum; and
means for performing a Max operation on the energy spectrum generated by said Min operation; and
means for subtracting the energy spectrum generated by said Max operation from said energy spectrum derived from said material.

42. The system of claim 41 further comprising:
means for performing linear smoothing on the energy spectrum generated be said means for subtracting.

43. The system of claim 29 wherein said processing means further comprises:
means for performing median filtering of said energy spectrum;
means for performing Min/Max filtering on the energy spectrum after said median filtering;
means for performing linear smoothing on the energy spectrum generated after said Min/Max filtering.

44. The system of claim 29 wherein said processing means further comprises using projection onto corner sets for deconvolution of one or more peaks in said energy spectrum.

45. The system of claim 29 wherein said classifying means comprises subjecting said features to processing in a classifier.

46. The system of claim 45 wherein said classifier is a multilayer perceptron network.

47. The system of claim 45 wherein said classifier is a neural tree network.

48. The system of claim 29 wherein said means for extracting one or more features from said energy spectrum includes means for applying a transform to said spectrum so as to provide a set of coefficients such that each said coefficient depends on the entirety of said spectrum, said set of features including at least some of said coefficients provided by said transform.

49. The system of claim 48 wherein said transform is a homomorphic transform.

50. The system of claim 48 wherein said transform is a cepstrum transform yielding an ordered set of cepstral coefficients and wherein the set of features includes a set of cepstral coefficients.

51. The system of claim 50 wherein said set of features consists entirely of said cepstral coefficients.

52. The system of claim 48 wherein said transform is a discrete cosine transform.

53. The system of claim 29 wherein said means for classifying is performed so as to provide structure classification information representing the likelihood that said object contains any of several known hazardous materials.

54. The system of claim 53 wherein said hazardous material is selected from Cs-137, Co-57, Co-60, Thorium 232, Am-241, Barium-133, Cs-137 and Co-60.

55. The system of claim 29 further comprising employing sodium iodide crystals, SAI and cadmium zinc tanzanium as gamma ray detectors for detecting said nuclear radiation.

56. The system of claim 29 further comprising employing a hand held detector for detecting said nuclear radiation.
